(19) United States
(12) Patent Application Publication
(10) Pub. No.: US 2022/0227537 A1
(43) Pub. Date: Jul. 21, 2022

(54) TEA BAG HOLDER

(71) Applicant: Lauren GESCHEL, Philadelphia, PA (US)

(72) Inventor: Lauren GESCHEL, Philadelphia, PA (US)

(21) Appl. No.: 17/606,963

(22) PCT Filed: Sep. 26, 2018
(86) PCT No.: PCT/US2018/052885

§ 371 Date: Oct. 27, 2021

Related U.S. Application Data
(60) Provisional application No. 62/564,078, filed on Sep. 27, 2017.

(51) Int. Cl. B65D 25/20; B65D 85/812; A23F 3/18; A45F 3/16

(52) U.S. Cl. CPC B65D 25/20; B65D 85/812; A45F 2003/001; A45F 3/16; A23F 3/18

(57) ABSTRACT

A tea bag holder and method of its use is provided, for storage and transport of a tea bag. The holder can be temporarily attached to a beverage container. The holder can hold a tea bag before use or enclose a used tea bag for later reuse or disposal. The holder may incorporate a permeable surface for draining moisture to a separate area of the holder or to the beverage container, which preserves the tea bag for reuse.

### FIELD OF INVENTION

The subject matter of the present application pertains to the field of beverage accessories. It is particularly related to a tea bag holder that is removably attachable to a beverage container, and methods of use therefor.

### BACKGROUND

A tea bag, used or unused, must be carefully handled at all times. In general, tea bags are physically delicate. Unused tea leaves are susceptible to damage from moisture, air, sunlight, heat, and strong odors. A used tea bag is damp, will leak, and may stain other objects. One tea bag may be reused multiple times, which requires careful storage between uses so as to appropriately discharge moisture, avoid contamination, and prevent accidental leaks and stains. At the same time, consumers often drink tea throughout a day or a commute using a portable disposable cup or reusable travel mug. Conventionally, a used tea bag is placed on a spoon or napkin, is placed in an additional disposable container, or stays in a beverage container with the tea beverage. Therefore, a need exists for a device to promote portability or reuse of a tea bag while reducing the waste and damage associated with handling a used tea bag.

The present disclosure is directed to overcoming one or more problems of the prior art, including portability, ease of reusing tea bags, cleanliness, cost, difficulty of assembly, etc. The present disclosure is particularly applicable to use with individual tea bags.

### SUMMARY

In one aspect, the present disclosure is directed to a method of using a tea bag, including providing a holder having a closeable storage area, attaching the holder to a beverage container, placing the tea bag in the closeable storage area.

In another aspect, the step of attaching is performed by encircling a band about the beverage container.

In another aspect, the method further includes closing the closeable storage area of the holder.

In another aspect, the method further includes removing the tea bag from the closeable storage area, and placing the tea bag in a liquid in the beverage container.

In another aspect, the method further includes transporting the beverage container while the holder is attached thereto.

In another aspect, the holder is part of a lid for the beverage container.

In another aspect, the method further includes draining moisture from the tea bag to a separate area.

In another aspect, the closeable storage area is an insert within the holder, the insert having a permeable wall.

In another aspect, the step of placing the tea bag in the closeable storage area is performed with the tea bag in a used state, and the method further includes removing the tea bag from the closeable storage area, and reusing the tea bag in the beverage container.

In another aspect, the step of placing the tea bag in the closeable storage area is performed with the tea bag in an unused state, and the method further includes removing the tea bag from the closeable storage area, using the tea bag with a liquid in the beverage container, replacing the tea bag in the closeable storage area, the tea bag being in a used state, wherein the closeable storage area has a permeable surface, and draining moisture from the tea bag to a separate area via the permeable surface.

In yet another aspect, the present disclosure is directed to a holder for a tea bag, the holder having a resilient strap, a pouch, and an insert. The pouch includes a front wall, a rear wall, sidewalls, an opening, and a closure for the opening. The insert has a permeable surface, and is configured to hold and drain moisture from a tea bag and the pouch is configured to hold drained moisture.

In yet another aspect, the present disclosure is directed to a holder for a tea bag, the holder having a lid and a storage area.

In yet aspect, the present disclosure is directed to a method of storing a tea bag, comprising providing a holder, attaching the holder, placing the tea bag, and closing. The holder has a closeable storage area. The holder is attached to a beverage container. The tea bag is placed in the holder. The closeable storage area of the holder is closed.

In yet another aspect, the present disclosure is directed to a method of storing a used tea bag, comprising providing a holder, attaching the holder to a beverage container, the holder having a closeable storage area and a permeable surface. The method further includes placing the used tea bag in the holder, closing the storage area of the holder, and draining moisture from the used tea bag to the beverage container.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is a side elevation view of a tea bag holder and a container according to a first embodiment of the present invention;

FIG. 2A is a side elevation view of a tea bag holder and a container according to a second embodiment of the present invention;

FIG. 2B is a partially exploded perspective view of the tea bag holder of FIG. 2A;

FIG. 3 is a side elevation view of a tea bag holder according to a third embodiment of the present invention;

FIG. 4 is a top plan view of a tea bag holder according to a fourth embodiment of the present invention;

FIG. 5 is a top plan view of a tea bag holder according to a fifth embodiment of the present invention;

FIG. 6A is a side elevation view of a tea bag holder according to a sixth embodiment of the present invention;

FIG. 6B is a top plan view of the tea bag holder of FIG. 6A;

FIG. 6C is a bottom perspective view of an aspect of a lid for the tea bag holder of FIG. 6A;

FIG. 7A is a side perspective view of a tea bag holder according to a seventh embodiment of the present invention; and

FIG. 7B is a side view of the tea bag holder of FIG. 7A with a portion removed.

### DETAILED DESCRIPTION OF THE PREFERRED EMBODIMENTS

Certain terminology is used in the following description for convenience only and is not considered limiting. Words such as “front”, “back”, “top” and “bottom” designate directions in the drawings to which reference is made. This terminology includes the words specifically noted above, derivatives thereof and words of similar import. Additionally, the terms “a” and “one” are defined as including one or more of the referenced item unless specifically noted. The phrase “at least one” followed by a list of two or more items (such as “at least one of A, B, or C”) means any individual one of A, one of B, or one of C as well as any combination of two or three thereof.

At the outset, it is understood that this invention is not limited only to the particular embodiments, methodology, materials, and modifications described herein, and as such may vary. It is also understood that the terminology used herein is for the purpose of describing particular aspects only, and is not intended to limit the scope of the present invention, which is limited only by the appended claims. In general, in the illustrated embodiments, similar parts are given similar reference numerals, e.g., pouches/holders 20/120/220/320/420/520/570/620, and these parts may have all or some of the same features. Generally, a tea bag “holder” as described is a term applicable to any of the pouches/holders 20/120/220/320/420/520/570/620. Likewise a “closeable storage area” as described is a term applicable to insert 160, storage area 570, or any of the other pouches/holders 20/120/220/320/420/520/620.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

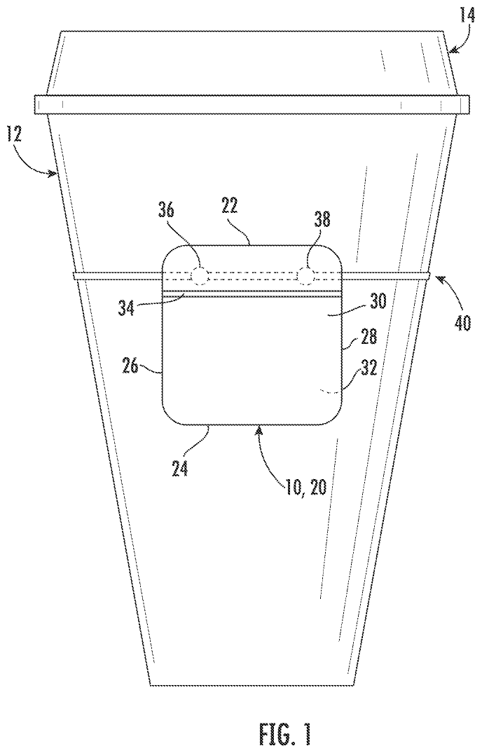

FIG. 1 shows an exemplary embodiment of a tea bag holder 10, also referred to as a “tea trap,” constituting a resealable pouch 20 attached to a beverage container 12 having a lid 14. The pouch 20 includes a top wall 22, bottom wall 24, sidewalls 26, 28, front wall 30, and rear wall 32. In some embodiments, the pouch 20 is formed from the front wall 30 secured directly to the rear wall 32 without any sidewalls, providing a slim, envelope-like structure.

A resealable closure 34 is formed in the front wall 30. The resealable closure 34 may be, for example, a zip-top, a slider seal, a press seal, a double zipper seal, hook and loops fasteners, a tacky material, or any other type of resealable closure. A flap extending from the rear wall 32 may be provided to function as the resealable closure 34, with or without additional fastening means to hold the flap closed against the front wall 30. In alternative embodiments, the closure 34 may not be resealable. In other embodiments, the closure 34 may be configured to independently maintain an open position to aid insertion and removal of a tea bag.

The rear wall 32 of the pouch 20 contains a receiver for mounting the pouch to a band 40. In the illustrated embodiment, the receiver includes two openings 36, 38 that are sized to allow the band 40 to pass through. This configuration allows a slidable relationship between the pouch 20 and the band 40, so that the pouch can be adjustably positioned about the beverage container 12 or the pouch can be reformed if bunching occurs during use.

The band 40 is preferably resilient, and may be an elastic band such as a rubber band formed in a loop with a diameter sized to stretch to fit about and encircle the various sizes of most beverage containers 12. In one exemplary embodiment, the band 40 is a polymer-rubber blend that is about ⅛ of an inch wide. In particular, the band 40 may be formed of a blend of 55% polyester and 45% rubber. In another exemplary embodiment, the band 40 is a rubber band with a width of 1/16 of an inch and a thickness of 1/32 of an inch. The relatively small width and thickness reduce manufacturing costs while promoting portability and ease of use.

The band 40 is sized to fit around a beverage container and may have a circumference of about 5 to about 9 inches, preferably about 7 inches. In one embodiment, for assembly, a strip of material of about 8 inches in length is threaded through the receiver openings 36, 38 and tied, resulting in a circumference of about 7 inches.

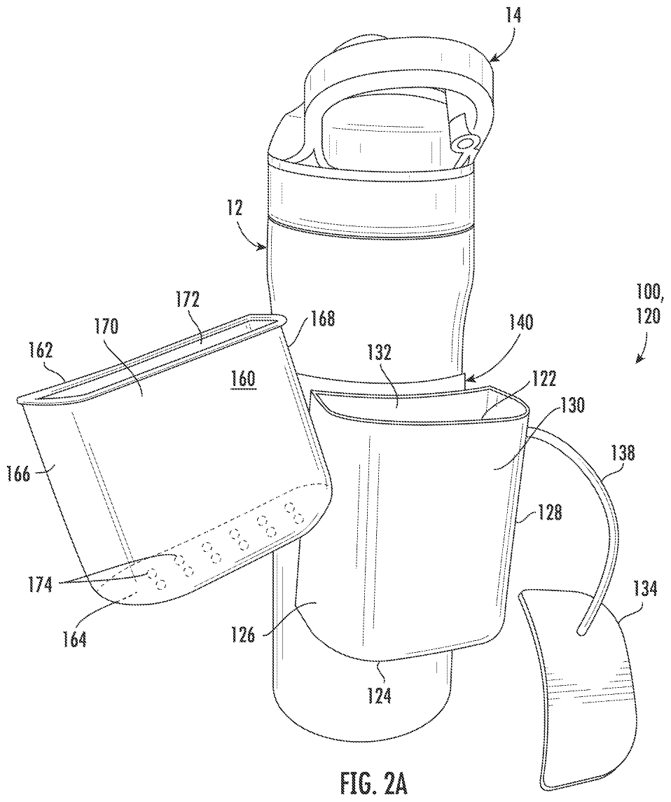

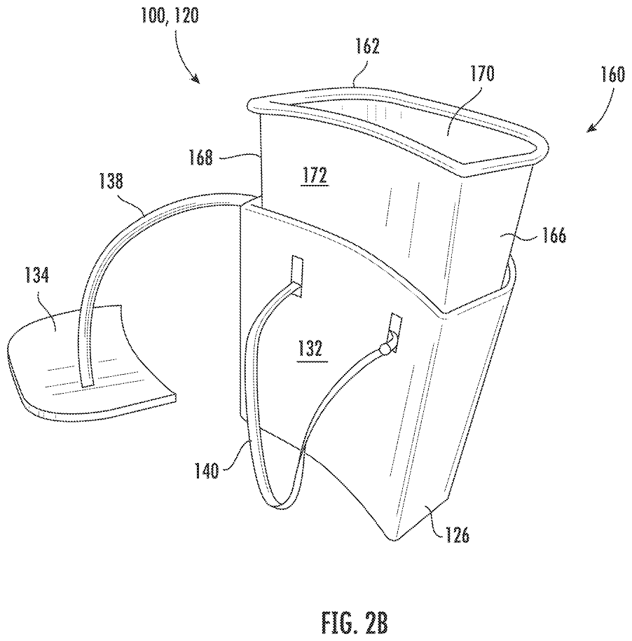

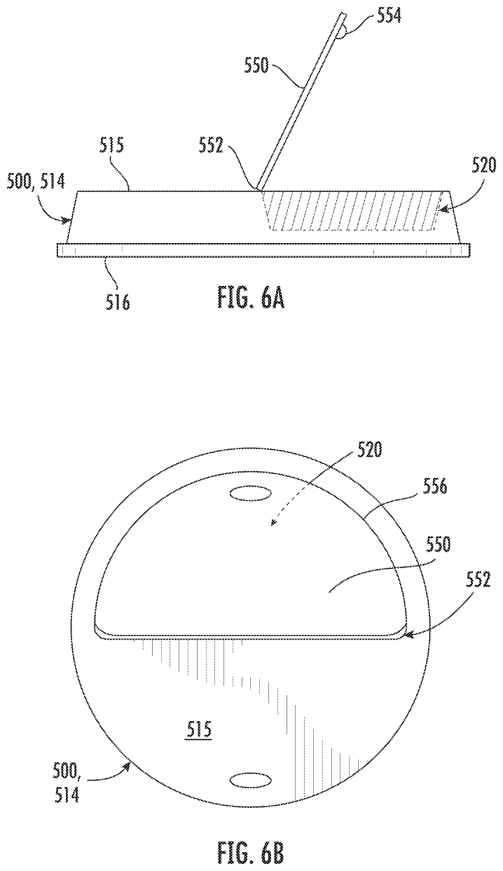

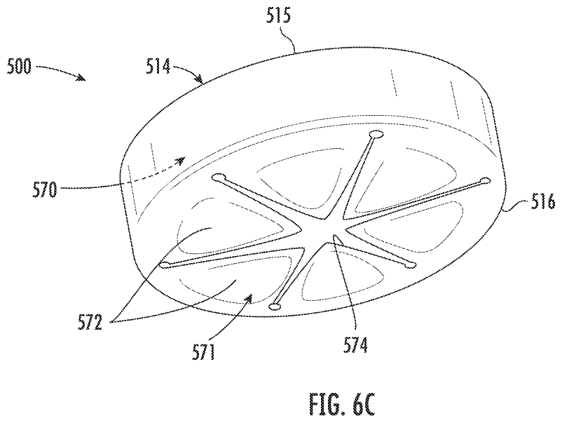

FIGS. 2A and 2B show another embodiment of a tea bag holder 100 including a pouch 120 and a band 140. The pouch 120 is larger, thicker, and more durable than pouch 20, and as such is suitable for reuse and repeated washing. Similar to the previous embodiment, the pouch 120 includes a top rim 122, bottom wall 124, sidewalls 126, 128, front wall 130, and rear wall 132. The rear wall 132 may have a slight curvature to better fit against the beverage container 12, and the front wall 130 may be similarly curved for a streamlined look and feel. The pouch 120 has a lid 134 for closing the pouch. In the illustrated embodiment, the lid 134 is fully removed from the pouch 120, with a tether 138 retaining the lid in near proximity. Alternatively, the lid 134 may be attached to the pouch 120 by a hinge in the same manner as hinge 552 as shown in FIGS. 6A-6B and described below.

As shown in FIG. 2B, the pouch 120 may include an insert 160 that is useful when reusing a tea bag 18. The insert 160 fits within the pouch 120, with an optional top rim 162, bottom wall 164, sidewalls 166, 168, front wall 170, and rear wall 172. The insert 160 is at least partially permeable. In one embodiment, the insert 160 is permeable due to perforations 174 formed in the bottom wall 164. In this manner, the bottom wall is a permeable surface of the insert 160. Alternatively, any other wall or walls of the insert 160 may constitute the permeable surface. After use, the tea bag 18 can be placed in the insert 160, which allows moisture to drain out to the pouch 120. The pouch 120 retains and stores this moisture to prevent leakage and possibly damage to nearby items. In this manner, the pouch 120 is considered a separate area of the tea bag holder 100 from the insert 160. The top rim 162 of the insert 160 is sized and configured to receive the lid 134 of the pouch 120. For example, the top rim 162 and the lid 134 (or a portion of the lid 134) can be sized for a friction fit. The top rim 162 and the bottom wall 164 are sized relative to the pouch 120 so that the insert bottom wall 164 is separated from the bottom wall 124 of the pouch 120. The volume of space defined by this separation contributes to or defines the separate area of the tea bag holder 100 mentioned above. In some embodiments, one or more of the walls 166/168/170/172 of the insert 160 may be spaced from the respective wall 126/128/130/132 of the pouch 120, providing volume to contribute to or define the separate area of the tea bag holder 100.

The band 140 in the illustrated embodiment of FIGS. 2A-2B may be relatively wide and formed of a strong material, e.g., woven nylon or silicone. The band 140 in some embodiments has a width of about ⅛ to about ¾ of an inch. The band 140 may have a greater thickness than the band 40, such as 1/16 of an inch or ⅛ of an inch. In general, a relatively larger band 140 provides improved holding strength against the beverage cup 12 or other mounting structure, greater frictional engagement with the beverage cup, and is more resistant to accidental breakage than the thin band 40 of the first embodiment.

FIG. 3 shows yet another embodiment of a tea bag holder 200 including a pouch 220 and a cozy 240. The cozy 240 is designed to mount to a beverage container 12 similarly to the band 40, but also provides insulation. The cozy 240 may have a height 242 that only covers a portion of the beverage container 12, similar to a sleeve for protecting a user's hands from heat. Alternatively, the height 242 of the cozy 240 may extend over substantially the entire beverage container 12, similar to a cozy for maintaining a temperature of a beverage within the container 12, e.g., a beer can cozy. The pouch 220 may be fixedly secured to the cozy 240, for example by stitching or permanent adhesive.

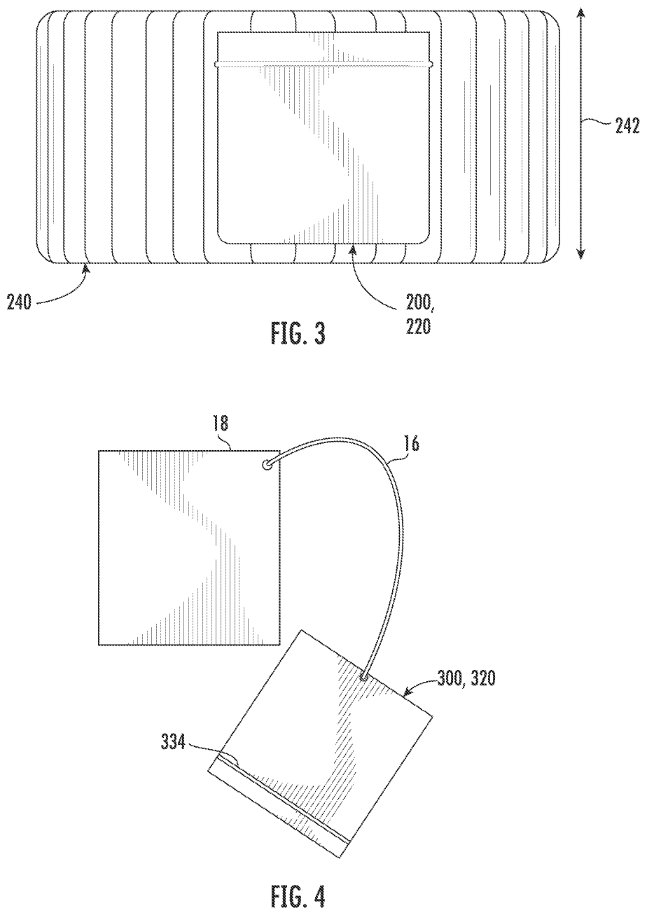

FIG. 4 shows still another embodiment of a tea bag holder 300 including a pouch 320 attached to a tea bag 18 via a string 16. Similar to a conventional tethered paper tag, the holder 300 is tethered to the tea bag 18 to allow a user to insert and remove the tea bag 18 from a beverage. Likewise the holder 300 can remain outside of the beverage container 12 while the tea bag 18 seeps inside the container.

The pouch 320 can be used to store the tea bag 18 before use or after use. The tea bag 18 may be reused after temporary storage in the pouch 320. Moreover, the pouch 320 may be easily transported by a user (e.g., by hand, in a pocket, in a backpack, in a purse, and/or in a vehicle) while preventing the used tea bag 18 from leaking or staining. The pouch 320, similar to previous embodiments, may include a resealable closure 334.

In addition to typical tag functions, the pouch 320 of the holder 300 can be used in the same manner as the pouch 20/120/220 of the present disclosure with a band 40/140 or a cozy 240 for selectively mounting to a beverage container 12.

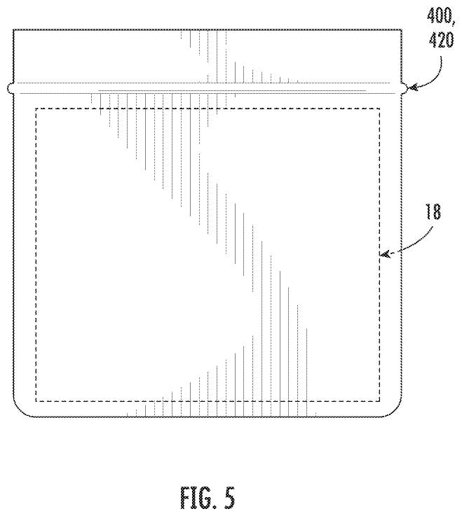

FIG. 5 shows another embodiment of a tea bag holder 400 that is substantially similar to the holder 300, but does not have a string between a pouch 420 and the tea bag 18. In other words, the tea bag holder 400 and the tea bag 18 are readily and completely separable. The holder 400 may be sold with the tea bag 18 by the tea manufacturer or distributor. In this manner, the holder 400 provides the aforementioned pouch functions in a ready-to-use unit. The pouch 420 may be disposable or reusable. In effect, the tea bag holder 400 improves the function of a tear-open package (e.g., a paper or foil envelope) for a single tea bag 18 with a closeable and reusable functionality. The tea bag holder 400 may be mountable to a beverage container 12 via a band 40/140 or a cozy 240 as discussed in the previous embodiments. The pouch 420 may be closeable by a releasable closure in the same manner as the previously described pouches 20/120/220/320.

FIGS. 6A and 6B show an embodiment of a tea bag holder 500 that functions similarly to the previous embodiments by means of a storage area 520 built into a lid 514. The lid includes a top wall 515 and a bottom rim 516. The storage area 520 is part of the lid 514 and is enclosed by a cap 550 that is attached to the lid by means of a hinge 552. A catch 554 or similar latching structure is used to close the cap 550. In the illustrated embodiment, the storage area 520 is a semicircular volume embodying approximately half of the lid 514. Generally, the storage area 520 may be any size so long as it can hold the tea bag 18 therein.

The storage area 520 functions to hold and protect a tea bag 18 in an unused or used state. As such, the cap 550 may provide a leak-proof seal with a perimeter 556 of the storage area 520. The leak-proof seal of cap 550 may be, for example, a gasket or the like.

In a further aspect shown in FIG. 6C, the lid 514 has a storage area 570 that is in communication with the beverage container 12 by way of a deformable wall 571. The deformable wall 571 is formed by a plurality of flaps 572 cantilevered toward a central area 574. The flaps 572 are strong enough to hold a soaked tea bag 18, yet one or more openings 574 between the flaps allows moisture from the tea bag to drip down into the beverage container 12. In this manner, the deformable wall 571 is a permeable surface of the storage area 570. Alternatively, any other wall or walls of the lid 514 may constitute the permeable surface. The flaps 572 may be flexible and/or resilient, so as to allow for quick and easy insertion/removal of the tea bag 18 from the storage area 520 and to make the storage area 570 closeable. At the same time, the top wall 515 of the lid 512 in a some embodiments is completely enclosed, preventing damage or contamination to the tea bag 18, or substantially closed with small ventilation opening(s). After use, the tea bag 18 can be placed in the storage area 570 above the flaps 572, which allows moisture to drain out through the openings 574 to the beverage container 12. In this manner, the beverage container 12 is considered a separate area from the storage area 570.

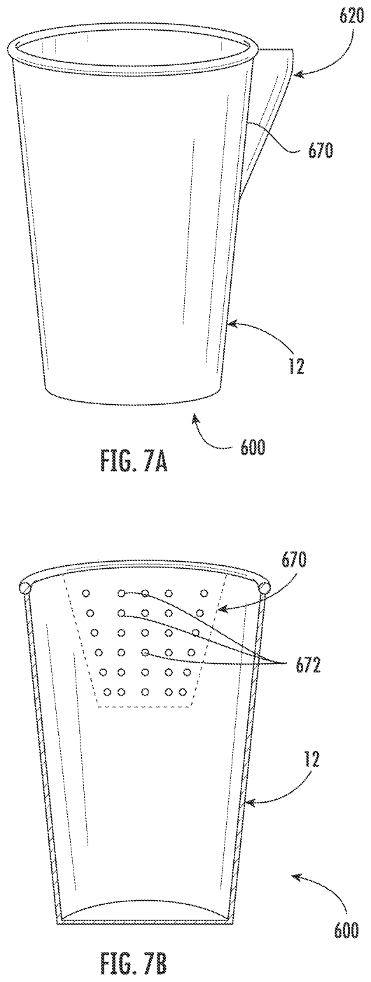

FIGS. 7A and 7B show yet another embodiment of a tea bag holder 600 that is formed into a wall of a beverage container 12. The storage area 620 may be integrally formed with the beverage container. A permeable wall 670 provides a permeable surface that separates the storage area 620 and the beverage container 12, while allowing moisture from the tea bag 18 to dip through. The permeable wall 670 as illustrated includes a plurality of openings or perforations 672, formed in the wall, the wall otherwise being a solid material. In this manner, the permeable wall 670 may be integrally formed with the beverage container 12; in other words, the permeable wall is formed of the same material(s) during the same manufacturing process(es). Alternatively, the permeable wall 670 may be formed of a mesh or netting, similar to a typical tea strainer. After use, the tea bag 18 can be placed in the storage area 620, which allows moisture to drain out to the beverage container 12. In this manner, the beverage container 12 is considered a separate area from the storage area 620.

The material of the pouch 20/120/220/320/420 and storage area 520/620 may be opaque, transparent, or semitransparent, and may be formed of various materials such as plastic, silicone, paperboard, and the like. For example, the pouch 20/120/220/320/420 may be formed of a rubber, neoprene, a fabric, cardboard, paperboard, or combinations thereof. In one embodiment, the pouch 20/120/220/320/420 is formed of an opaque LDPE material having a thickness of about 4 mil. Generally, the pouch 20/120/220/320/420 and storage area 520/620 may be any shape and size suitable for holding a tea bag. In some embodiments, the front wall 30 and the rear wall 32 are substantially square shaped, with a length of about 3 inches and a width of about 3 inches.

Likewise, the band 40/140 or cozy 240 may be formed of various materials including rubber, elastics, polyester, fabric, knitted fabric, and combinations thereof. In general, the material of the pouch 20/120/220/320/420, the band 40/140, and/or the cozy 240 may be chosen so as to be machine washable, dishwasher-safe, biodegradable, or recyclable, or combinations thereof. Similarly, the tea bag holder 500/600 including the storage area 520/570/620 may be formed of a plastic, polymer, or metal, and the material may be chosen so as to be dishwasher-safe, biodegradable, or recyclable, or combinations thereof.

The various embodiments of the tea bag holder 100-600 may be sold individually, in multi-packs, in conjunction with tea bags, in conjunction with beverage containers, or in conjunction with other tea-drinking accessories. The tea bag holder 100-600 of the present disclosure may be used for various other beverages including coffee (e.g., single-serve coffee cartridges), protein powder and other workout supplements, flavor packs, sugar packets, and the like. The tea bag holder 100-600 of the present disclosure is applicable to any beverage container, mug, travel mug, bottle, and the like.

Aspects of the disclosed embodiments 100-600 may be substituted or combined in various ways. For example, any pouch 20/120/220/320/420 may be combined with any band 40/140/240 for encircling the beverage container 12. The storage area 520 may have a permeable portion to drain to the beverage container 12, similar to the deformable wall 571 or the permeable wall 670. Instead of the tether 138, the lid 134 of the pouch 120 may be attached to the pouch by a hinge in the same manner that the cap 550 attaches to the lid 514 by the hinge 552. Instead of the deformable wall 571, the lid 514 or the storage area 570 may be perforated similarly to the permeable wall 670, with access to the storage area 570 provided by the cap 550.

The tea bag 18 of the present application is any applicable permeable bag/pouch having tea, loose leaf tea, herbal tea, or another beverage infuser (coffee, chocolate powder/syrup, protein powder, other powdered mixes, citrus fruit, and the like) that is made to be inserted or steeped into a liquid beverage in the beverage container 12. The tea bag 18 may be a manufactured product, hand-made, or homemade. The tea bag may be made of porous paper, fabric, woven fabric, silk, nylon or similar materials. The tea bag 18 is considered “unused” when it is substantially dry and has not yet been inserted into a liquid beverage. The tea bag 18 is considered “used” when it has been inserted into a liquid beverage at least once.

In “reusing” the tea bag 18 for any of the above embodiments, the used tea bag 18 (which, after use, may be in a saturated or semi-saturated state) is removed from the beverage container 12 and placed in the holder (pouch 20/120/220/320/420 or the storage area 520/570/620). In this manner, the tea bag 18 is no longer immersed in any liquid that remains in the beverage container 12. If the tea bag 18 is placed in the insert 160 or the storage area 570/620, then draining and eventual drying of the tea bag 18 are promoted, such that the tea bag 18 is significantly less saturated after a relatively short period of time. Generally, reuse of any tea bag is more effective if the used tea bag can be drained and dried (partially or completely). Then, the tea bag 18 may be placed in liquid (such as hot water) in the beverage container 12 or in another container, so as to seep and provide a second tea beverage.

Having thus described the presently preferred embodiments in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiments and optional configurations are therefore to be considered in all respects as exemplary and/or illustrative and not restrictive, the scope of the invention being indicated by the appended claims rather than by the foregoing description, and all alternate embodiments and changes to this embodiment which come within the meaning and range of equivalency of said claims are therefore to be embraced therein.

What is claimed is:

1. A method of using a tea bag, characterized by:
providing a holder having a closeable storage area;
attaching the holder to a beverage container; and
placing the tea bag in the closeable storage area.

2. The method of claim 1, wherein the step of attaching is performed by encircling a band about the beverage container.

3. The method of claim 1, further characterized by:
closing the closeable storage area of the holder.

4. The method of claim 1, further characterized by:
removing the tea bag from the closeable storage area; and
placing the tea bag in a liquid in the beverage container.

5. The method of claim 1, further characterized by:
transporting the beverage container while the holder is attached thereto.

6. The method of claim 1, wherein the holder is part of a lid for the beverage container.

7. The method of claim 1, further characterized by:
draining moisture from the tea bag to a separate area.

8. The method of claim 7, wherein the closeable storage area is an insert within the holder, the insert having a permeable wall.

9. The method of claim 8, further characterized by:
the step of placing the tea bag in the closeable storage area is performed with the tea bag in a used state;
removing the tea bag from the closeable storage area; and
reusing the tea bag in the beverage container.

10. The method of claim 1, further characterized by:
the step of placing the tea bag in the closeable storage area is performed with the tea bag in an unused state,
removing the tea bag from the closeable storage area;
using the tea bag with a liquid in the beverage container;
replacing the tea bag in the closeable storage area, the tea bag being in a used state, wherein the closeable storage area has a permeable surface; and
draining moisture from the tea bag to a separate area via the permeable surface.
